(19) United States
(12) Patent Application Publication
(10) Pub. No.: US 2015/0101548 A1
(43) Pub. Date: Apr. 16, 2015

(54) APPARATUS AND METHOD FOR AN ANIMAL RESTRAINT SYSTEM

(71) Applicant: Billy J. Amos, Chattanooga, TN (US)

(72) Inventor: Billy J. Amos, Chattanooga, TN (US)

(21) Appl. No.: 14/511,777

(22) Filed: Oct. 10, 2014

Related U.S. Application Data
(60) Provisional application No. 61/961,295, filed on Oct. 10, 2013.

(51) Int. Cl. A01K 27/00; A01K 15/02

(52) U.S. Cl. CPC A01K 27/003; A01K 15/02; A01K 27/001
USPC 119/793

(57) ABSTRACT

An animal restraint system adapted for use on an animal having a neck and shoulders comprising a leash having a first end and a second end spaced apart from the first end, a fastener disposed near the first end of the leash and adapted to be fastened to a collar worn by the animal, a handle disposed near the second end of the leash and adapted to be held by a user, a braking mechanism disposed near the handle, a first ring disposed between the first end and the second end of the leash and having a first ring opening adapted to allow a portion of the leash to pass therethrough, and a second ring disposed near the handle and having a second ring opening adapted to allow a portion of the leash to pass therethrough. A method comprising applying a pulling force to the handle and/or the handling loop.

### CROSS-REFERENCES TO RELATED APPLICATIONS/PATENTS

This application relates back to and claims the benefit of priority from U.S. Provisional Application for Patent Ser. No. 61/961,295 entitled “Apparatus and Method for a Dog Leash” and filed on Oct. 10, 2013.

### FIELD OF THE INVENTION

The present invention relates generally to animal restraints, and particularly to leashes adapted to control and train dogs.

### BACKGROUND AND DESCRIPTION OF THE PRIOR ART

It is known to use animal restraints to control and train animals. Conventional animal restraints, however, suffer from one or more disadvantages. For example, conventional animal restraints do not sufficiently restrain or control all animals, particularly large, strong dogs. Conventional animal restraints also do not allow the user to adjust the restraint between a variety of configurations providing a plurality of correction and control points. In addition, conventional animal restraints do not efficiently restrain an animal by exerting resistant forces to the animal's shoulders. Further, conventional animal restraints are complicated and difficult to use, and they require excessive labor and time from the user. Still further, some conventional animal restraints are painful or harmful to the restrained animal and/or the user.

It would be desirable, therefore, if an apparatus and method for an animal restraint system could be provided that would be adapted to effectively restrain and control a large, strong animal such as a dog. It would also be desirable if such an apparatus and method for an animal restraint system could be provided that would be adapted to be configured in a variety of ways and provide a plurality of points of correction and control. It would be further desirable if such an apparatus and method for an animal restraint system could be provided that would be adapted to efficiently restrain and control an animal by exerting resistant forces to the animal's shoulders. It would be still further desirable if such an apparatus and method for an animal restraint system could be provided that would be adapted to be simple and easy to use. In addition, it would be desirable if such an apparatus and method for an animal restraint system could be provided that would be adapted to train and control an animal more quickly and with less human labor. It would also be desirable if such an apparatus and method for an animal restraint system could be provided that would be adapted to minimize or eliminate pain and harm to the restrained animal and the user.

### ADVANTAGES OF THE PREFERRED EMBODIMENTS OF THE INVENTION

Accordingly, it is an advantage of the preferred embodiments of the invention claimed herein to provide an apparatus and method for an animal restraint system that is adapted to effectively restrain and control a large, strong animal such as a dog. It is another advantage of the preferred embodiments of the invention claimed herein to provide an apparatus and method for an animal restraint system that is adapted to be configured in a variety of ways and provide a plurality of points of correction and control. It is a further advantage of the preferred embodiments of the invention claimed herein to provide an apparatus and method for an animal restraint system that is adapted to efficiently restrain an animal by exerting resistant forces to the animal's shoulders. It is a still further advantage of the preferred embodiments of the invention claimed herein to provide an apparatus and method for an animal restraint system that is adapted to be simple and easy to use. It is yet another advantage of the preferred embodiments of the invention claimed herein to provide an apparatus and method for an animal restraint system that is adapted to train and control an animal more quickly and with less human labor. In addition, it is an advantage of the preferred embodiments of the invention claimed herein to provide an apparatus and method for an animal restraint system that is adapted to minimize or eliminate pain and harm to the restrained animal and the user.

Additional advantages of the preferred embodiments of the invention will become apparent from an examination of the drawings and the ensuing description.

### SUMMARY OF THE INVENTION

The apparatus of the invention comprises an animal restraint system adapted for use on an animal having a neck and shoulders. The preferred animal restraint system comprises a leash having a first end and a second end spaced apart from the first end, a fastener disposed near the first end of the leash and adapted to be fastened to a collar worn by the animal, a handle disposed near the second end of the leash and adapted to be held by a user, a braking mechanism disposed near the handle, a first ring disposed between the first end and the second end of the leash and having a first ring opening adapted to allow a portion of the leash to pass therethrough, and a second ring disposed near the handle and having a second ring opening adapted to allow a portion of the leash to pass therethrough. In one preferred embodiment of the animal restraint system, a portion of the leash is passed through the first ring opening to form a restraining loop adjacent to the first end of the leash and a handling loop adjacent to the second end of the leash, the restraining loop is disposed around the neck or shoulders of the animal, the fastener is fastened to the collar worn by the animal, and the user holds the handle with a first hand and the handling loop with a second hand. In an alternative embodiment of the animal restraint system, a portion of the leash is passed through the first ring opening to form a restraining loop adjacent to the first end of the leash and a handling loop adjacent to the second end of the leash, the restraining loop is disposed around the neck or shoulders of the animal, the fastener is fastened to the collar worn by the animal, and the user holds the handling loop with a hand. In another alternative embodiment of the animal restraint system, a portion of the leash is passed through the second ring opening to form a restraining loop adjacent to the first end of the leash and a handling loop adjacent to the second end of the leash, the restraining loop is disposed around the neck or shoulders of the animal, the fastener is fastened to the collar worn by the animal, and the user holds the handle with a first hand and the handling loop with a second hand.

The method of the invention comprises providing an animal restraint system as described in the preceding paragraph, placing the restraining loop around the animal's neck or shoulders, fastening the fastener to the collar, and applying a pulling force to the handle and/or the handling loop of the animal restraint system.

### BRIEF DESCRIPTION OF THE DRAWINGS

The presently preferred embodiments of the invention are illustrated in the accompanying drawings, in which like reference numerals represent like parts throughout, and in which:

FIG. 1 is a top view of the preferred embodiment of the animal restraint system shown in the standard configuration in accordance with the present invention.

FIG. 2 is a front view of the preferred animal restraint system configuration illustrated in FIG. 1 disposed on an exemplary dog.

FIG. 3 is a top view of the preferred animal restraint system illustrated in FIGS. 1-2 shown in the correction and control configuration.

FIG. 4 is a front view of the preferred animal restraint system configuration illustrated in FIG. 3 disposed on an exemplary dog.

FIG. 5 is a top view of the preferred animal restraint system illustrated in FIGS. 1-4 shown in the working configuration.

FIG. 6 is a front view of the preferred animal restraint system configuration illustrated in FIG. 5 disposed on an exemplary dog.

### DESCRIPTION OF THE PREFERRED EMBODIMENTS OF THE INVENTION

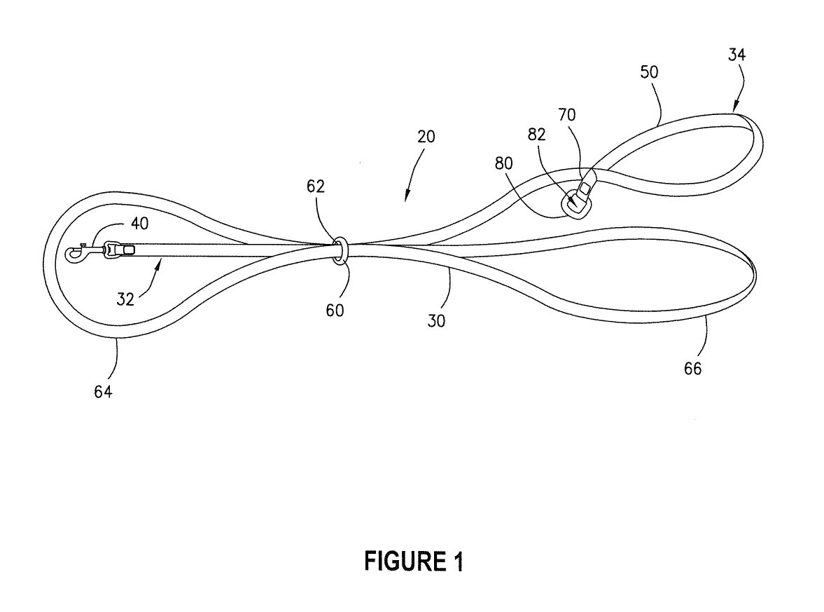

Referring now to the drawings, the preferred embodiments of the animal restraint system in accordance with the present invention are illustrated by FIGS. 1-6. As shown in FIGS. 1-6, the preferred animal restraint system is adapted to effectively restrain and control a large, strong animal such as a dog. The preferred animal restraint system is also adapted to be configured in a variety of ways and provide a plurality of points of correction and control. The preferred animal restraint system is further adapted to efficiently restrain an animal by exerting resistant forces to the animal's shoulders. The preferred animal restraint system is still further adapted to be simple and easy to use. In addition, the preferred animal restraint system is adapted to train and control an animal more quickly and with less human labor. The preferred animal restraint system is also adapted to minimize or eliminate pain and harm to the restrained animal and the user.

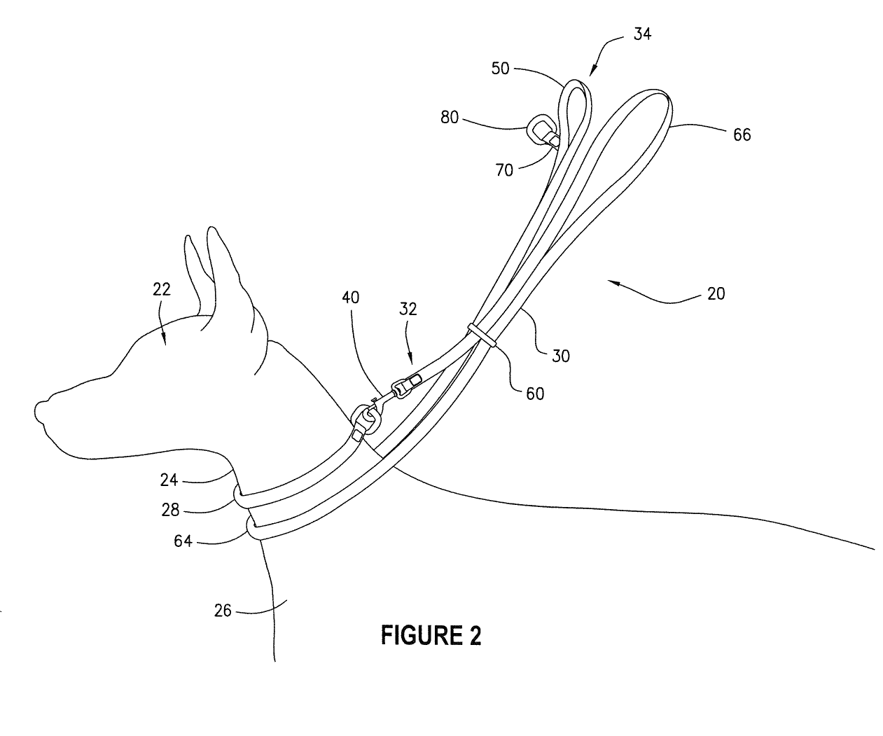

Referring now to FIG. 1, a top view of the preferred embodiment of the animal restraint system is illustrated in the standard configuration. As shown in FIG. 1, the preferred animal restraint system is designated generally by reference numeral 20. Preferred animal restraint system is adapted for use on an animal such as exemplary dog 22 having neck 24, shoulders 26, and collar 28 (see FIGS. 2, 4, and 6). Preferred animal restraint system comprises leash 30 having first end 32 and second end 34 which is spaced apart from the first end. Preferred leash 30 comprises an inelastic material such as nylon, leather, or the like, but it is contemplated within the scope of the invention that the leash may comprise any suitable material adapted to control and restrain an animal. Preferred animal restraint system 20 also comprises fastener 40 which is disposed near first end 32 of leash 30. Preferred fastener 40 is adapted to be removably fastened to collar 28 worn by exemplary dog 22, but it is contemplated within the scope of the invention that the fastener may be any device, mechanism, assembly, or combination thereof adapted to connect leash 30 to a collar worn by an animal. In addition, preferred animal restraint system 20 comprises handle 50 which is disposed near second end 34 of leash 30 and adapted to be held by a user such as a pet owner or an animal trainer. Preferred handle 50 comprises a fixed loop, but it is contemplated within the scope of the invention that the handle may be any device, mechanism, assembly, or combination thereof adapted to be held by the user.

Preferred animal restraint system 20 further comprises first ring 60 which is disposed between first end 32 and second end 34 of leash 30. Preferred first ring 60 includes first ring opening 62 which is adapted to allow a portion of leash 30 to pass through it. More particularly, preferred first ring 60 allows the user to pass a portion of leash 30 through it so as to form restraining loop 64 which is disposed near first end 32 of leash 30 and handling loop 66 which is disposed near second end 34 of the leash. Preferred first ring 60 comprises an O-ring adapted to move along the leash between the first end and the second end but it is contemplated within the scope of the invention that the first ring may be of any suitable configuration. Still further, preferred animal restraint system 20 comprises braking mechanism 70 which is disposed near handle 50. Preferred braking mechanism 70 comprises a strip of inelastic material adapted to prevent handle 50 from passing through first ring 60, but it is contemplated within the scope of the invention that the braking mechanism may be any device, mechanism, assembly, or combination thereof adapted to prevent second end 34 of leash 30 from moving toward or passing through first ring 60. Preferred animal restraint system 20 also comprises second ring 80 which is disposed near handle 50. Preferred second ring 80 includes second ring opening 82 which is adapted to allow a portion of leash 30 to pass through it. Preferred second ring 80 comprises an O-ring fixedly disposed near the handle but it is contemplated within the scope of the invention that the second ring may be of any suitable configuration.

Referring now to FIG. 2, a front view of preferred animal restraint system 20 disposed on an exemplary dog in the standard configuration is illustrated. As shown in FIG. 2, preferred animal restraint system 20 comprises leash 30, fastener 40, handle 50, first ring 60, braking mechanism 70, and second ring 80. More particularly, as shown in FIG. 2, a portion of leash 30 is passed through first ring 60 so as to form restraining loop 64 and handling loop 66. Preferred restraining loop 64 is adjacent to first end 32 of leash 30 and preferred handling loop 66 is adjacent to second end 34 of the leash. In addition, preferred restraining loop 64 is disposed around neck 24 or shoulders 26 of an animal such as exemplary dog 22, and preferred fastener 40 is fastened to collar 28 worn by the animal. Preferably, a user holds handle 50 with one hand and holds handling loop 66 with the other hand. In this standard configuration of preferred animal restraint system 20, the user has two points of control, i.e., handle 50 and handling loop 66 which is spaced apart from the handle. In the alternative, the user can hold handle 50 and handling loop 66 with the same hand or with both hands such that the user has a single point of control i.e., the handle and the handling loop which are held together and not spaced apart from each other.

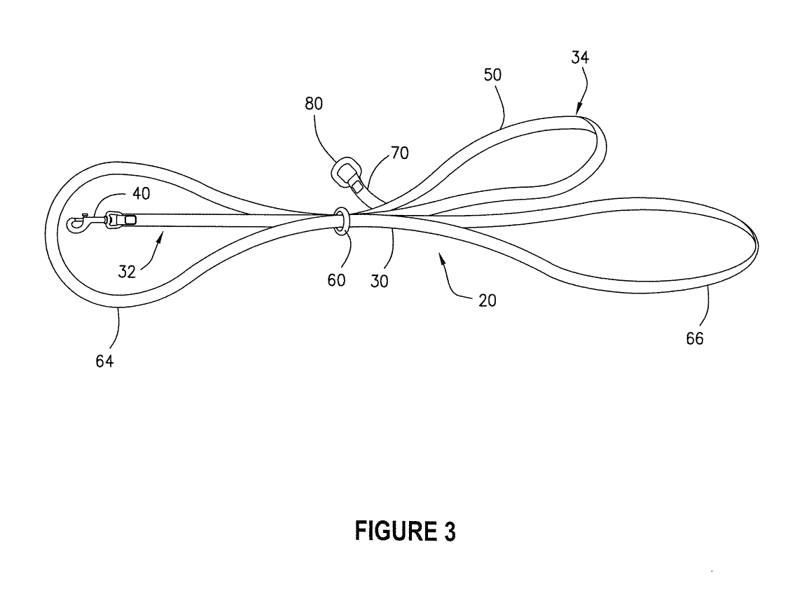

Referring now to FIG. 3, a top view of preferred animal restraint system 20 is illustrated in the correction and control configuration. As shown in FIG. 3, preferred animal restraint system 20 comprises leash 30, fastener 40, handle 50, first ring 60, restraining loop 64, handling loop 66, braking mechanism 70, and second ring 80. As also shown in FIG. 3, when the preferred animal restraint system 20 is in the correction and control configuration, second end 34 of leash 30 is moved towards first ring 60 until braking mechanism 70 abuts the first ring. Preferably, braking mechanism prevents handle 50 from passing through first ring 60.

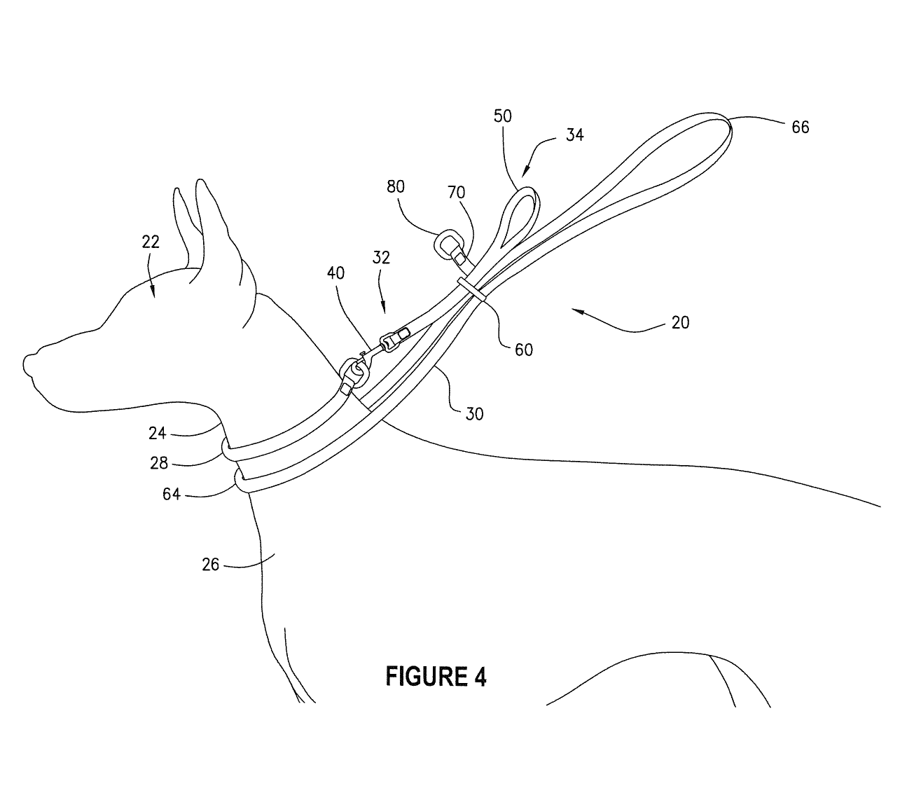

Referring now to FIG. 4, a front view of preferred animal restraint system 20 disposed on an exemplary dog in the correction and control configuration is illustrated. As shown in FIG. 4, preferred animal restraint system 20 comprises leash 30, fastener 40, handle 50, first ring 60, restraining loop 64, handling loop 66, braking mechanism 70, and second ring 80. More particularly, as shown in FIG. 4, a portion of leash 30 is passed through first ring 60 so as to form restraining loop 64 and handling loop 66. Preferred restraining loop 64 is adjacent to first end 32 of leash 30 and preferred handling loop 66 is adjacent to second end 34 of the leash. In addition, preferred restraining loop 64 is disposed around neck 24 or shoulders 26 of exemplary dog 22, and preferred fastener 40 is fastened to collar 28 worn by the animal. Preferably, a user holds handling loop 66 with one hand and allows second end 34 of leash 30 to move towards first ring 60 until braking mechanism 70 abuts the first ring. In this correction and control configuration of preferred animal restraint system 20, the user has one point of control, i.e., handling loop 66.

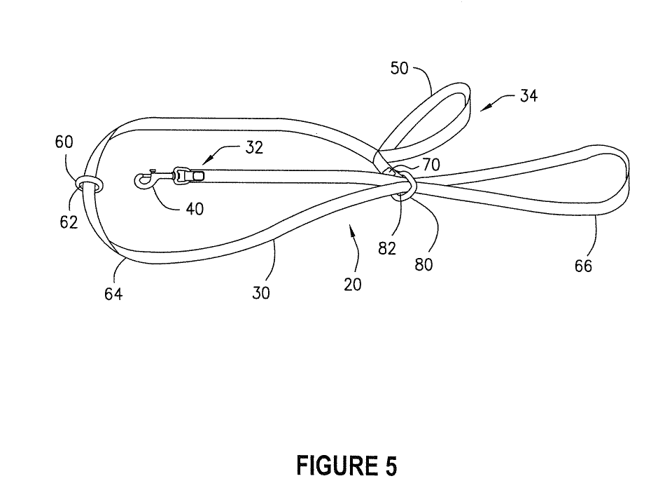

Referring now to FIG. 5, a top view of preferred animal restraint system 20 is illustrated in the working configuration. As shown in FIG. 5, preferred animal restraint system 20 comprises leash 30, fastener 40, handle 50, first ring 60, restraining loop 64, handling loop 66, braking mechanism 70, and second ring 80. As also shown in FIG. 5, when the preferred animal restraint system 20 is in the working configuration, a portion of leash 30 is passed through second ring opening 82 to form restraining loop 64 which is adjacent to first end 32 of leash 30 and handling loop 66 which is adjacent to second end 34 of the leash.

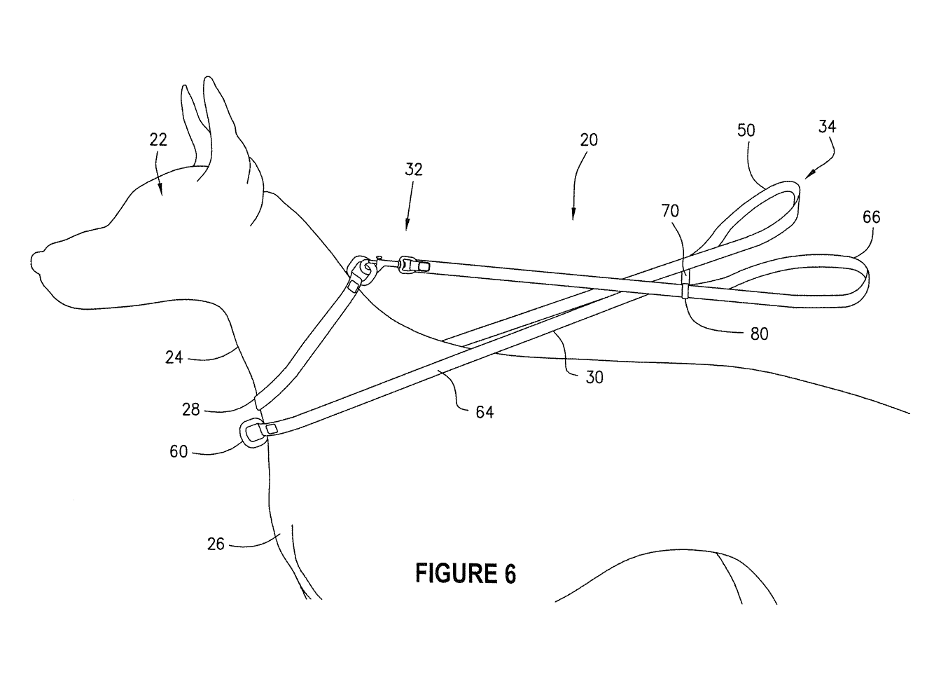

Referring now to FIG. 6, a front view of preferred animal restraint system 20 disposed on an exemplary dog in the working configuration is illustrated. As shown in FIG. 6, preferred animal restraint system 20 comprises leash 30, fastener 40, handle 50, first ring 60, restraining loop 64, handling loop 66, braking mechanism 70, and second ring 80. More particularly, as shown in FIG. 6, when preferred animal restraint system 20 is in the working configuration, restraining loop 64 is disposed around neck 24 or shoulders 26 of dog 22, fastener 40 is fastened to collar 28 worn by the dog, and the user holds handle 50 with a first hand and handling loop 66 with a second hand. In this configuration, the user has two control points, i.e., handle 50 and handling loop 66 which is spaced apart from the handle. In the alternative, the user may hold handle 50 and handling loop 66 with one hand or with both hands so as to provide the user with one control point.

The invention also comprises a method for restraining an animal. The preferred method for restraining an animal comprises providing an animal restraint system as described and claimed herein. In addition, the preferred method for restraining an animal comprises passing a portion of the leash through the first ring opening to form a restraining loop adjacent to the fastener and a handling loop adjacent to the handle. The preferred method for restraining an animal also comprises disposing the restraining loop around the neck or shoulders of the animal and fastening the fastener to the collar worn by the animal. The preferred method for restraining an animal further comprises holding the handle with a first hand and holding the handling loop with a second hand. In the alternative, the handle and the handling loop may be held together with one of the user's hands or both of the user's hands in order to provide a single control point. In another alternative method, the preferred method for restraining an animal comprises holding the handling loop with a hand and moving the second end of the leash toward the first ring. The preferred method further comprises applying a pulling force to the handle and/or the handling loop.

In another alternative method for restraining an animal, the preferred method comprises providing an animal restraint system as described and claimed herein. In addition, the preferred method for restraining an animal comprises passing a portion of the leash through the second ring opening to form a restraining loop adjacent to the fastener and a handling loop adjacent to the handle. The preferred method for restraining an animal also comprises disposing the restraining loop around the neck or shoulders of the animal and fastening the fastener to the collar worn by the animal. The preferred method for restraining an animal further comprises holding the handle with a first hand and holding the handling loop with a second hand. In an alternative method, the handle and the handling loop may be held together with one of the user's hands or both of the user's hands in order to provide a single control point. The preferred method further comprises applying a pulling force to the handle and/or the handling loop.

In operation, several advantages of the preferred embodiments of the apparatus and method for an animal restraint system are achieved. For example, the preferred embodiments of the animal restraint system are adapted to be configured in a variety of ways and provide a plurality of points of correction and control. As shown in the drawings, the preferred animal restraint system may be easily configured in (i) a standard configuration which is suitable for walking an animal (see FIGS. 1-2), (ii) a correction and control configuration which is suitable for training an animal (see FIGS. 3-4), and (iii) a working configuration which is suitable for search and rescue and seeing eye duties (see FIGS. 5-6).

In the standard configuration, a loop formed by a portion of the leash between the first end and the second end is partially passed through the first ring such that the fastener and a portion of the leash (the restraining loop) extend from the same end of the ring. Another portion of the leash (the handling loop) and the second end of the leash extend from the other end of the ring. The fastener is connected to the conventional collar worn by the animal, and the portion of the leash adjacent to the fastener (the restraining loop) is disposed around the animal's neck or shoulders. In the standard configuration, the user may use two hands and two correction and control points to restrain and control the animal; one hand on the handle and the other hand on the handling loop. In the alternative, the handle and the handling loop may be held together with one of the user's hands or both of the user's hands in order to provide a single point of control.

In the correction and control configuration, the preferred animal restraint system is generally configured and disposed on an animal the same way as the standard configuration. However, in the correction and control configuration, the user releases the second end of the leash and allows it to move towards the first ring until the brake mechanism prevents the second end from moving any closer to the first ring. In this configuration, the user uses only one correction and control point via the handling loop.

The working configuration, by contrast, is entirely different from the standard configuration and the correction and control configuration. In the working configuration, a loop formed by a portion of the leash between the first end and the second end is partially passed through the second ring which is disposed near the handle. The first ring is allowed to move along the restraining loop which is disposed around the animal's neck or shoulders, but it is preferably centered against the animal's body. The fastener is connected to the animal's collar. In this configuration, the user may use two hands and two correction and control points to restrain and control the animal. In the alternative, the user may use one hand to hold both the handle and the handling loop or both hands to hold the handle and the handling loop together in order to provide a single point of control.

An additional advantage of the preferred embodiments of the animal restraint system is that regardless of the configuration, the system is ambidextrous and can be used equally efficiently and easily by a left-hand dominant user or a right-hand dominant user. In addition, the preferred embodiments of the animal restraint system are adapted to be used equally efficiently and easily from the left side or the right side of the animal. Preferably, the animal restraint system is configured and disposed on an animal such that the fixed loop handle is disposed farther away from the animal than the handling loop.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. An animal restraint system adapted for use on an animal having a neck and shoulders, said animal restraint system comprising:
(a) a leash, said leash having a first end and a second end spaced apart from the first end;
(b) a fastener, said fastener being disposed near the first end of the leash and adapted to be fastened to a collar worn by the animal;
(c) a handle, said handle being disposed near the second end of the leash and adapted to be held by a user;
(d) a braking mechanism, said braking mechanism being disposed near the handle;
(e) a first ring, said first ring being disposed between the first end and the second end of the leash and having a first ring opening adapted to allow a portion of the leash to pass therethrough; and
(f) a second ring, said second ring being disposed near the handle and having a second ring opening adapted to allow a portion of the leash to pass therethrough;
wherein a portion of the leash is passed through the first ring opening to form a restraining loop adjacent to the first end of the leash and a handling loop adjacent to the second end of the leash, the restraining loop is disposed around the neck or shoulders of the animal, the fastener is fastened to the collar worn by the animal, and the user holds the handle with a first hand and the handling loop with a second hand.

2. The animal restraint system of claim 1 wherein the leash is inelastic.

3. The animal restraint system of claim 1 wherein the fastener is adapted to be removably fastened to the collar.

4. The animal restraint system of claim 1 wherein the handle comprises a fixed loop.

5. The animal restraint system of claim 1 wherein the braking mechanism is adapted to prevent the handle from passing through the first ring.

6. The animal restraint system of claim 1 wherein the first ring comprises an O-ring adapted to move along the leash between the first end and the second end.

7. The animal restraint system of claim 1 wherein the second ring comprises an O-ring fixedly disposed near the handle.

8. An animal restraint system adapted for use on an animal having a neck and shoulders, said animal restraint system comprising:
(a) a leash, said leash having a first end and a second end spaced apart from the first end;
(b) a fastener, said fastener being disposed near the first end of the leash and adapted to be fastened to a collar worn by the animal;
(c) a handle, said handle being disposed near the second end of the leash and adapted to be held by a user;
(d) a braking mechanism, said braking mechanism being disposed near the handle;
(e) a first ring, said first ring being disposed between the first end and the second end of the leash and having a first ring opening adapted to allow a portion of the leash to pass therethrough; and
(f) a second ring, said second ring being disposed near the handle and having a second ring opening adapted to allow a portion of the leash to pass therethrough;
wherein a portion of the leash is passed through the first ring opening to form a restraining loop adjacent to the first end of the leash and a handling loop adjacent to the second end of the leash, the restraining loop is disposed around the neck or shoulders of the animal, the fastener is fastened to the collar worn by the animal, and the user holds the handling loop with a hand.

9. The animal restraint system of claim 8 wherein the leash is inelastic.

10. The animal restraint system of claim 8 wherein the fastener is adapted to be removably fastened to the collar.

11. The animal restraint system of claim 8 wherein the handle comprises a fixed loop.

12. The animal restraint system of claim 8 wherein the braking mechanism is adapted to prevent the handle from passing through the first ring.

13. The animal restraint system of claim 8 wherein the first ring comprises an O-ring adapted to move along the leash between the first end and the second end.

14. The animal restraint system of claim 8 wherein the second ring comprises an O-ring fixedly disposed near the handle.

15. An animal restraint system adapted for use on an animal having a neck and shoulders, said animal restraint system comprising:
(a) a leash, said leash having a first end and a second end spaced apart from the first end;
(b) a fastener, said fastener being disposed near the first end of the leash and adapted to be fastened to a collar worn by the animal;
(c) a handle, said handle being disposed near the second end of the leash and adapted to be held by a user;
(d) a braking mechanism, said braking mechanism being disposed near the handle;
(e) a first ring, said first ring being disposed between the first end and the second end of the leash and having a first ring opening adapted to allow a portion of the leash to pass therethrough; and
(f) a second ring, said second ring being disposed near the handle and having a second ring opening adapted to allow a portion of the leash to pass therethrough;
wherein a portion of the leash is passed through the second ring opening to form a restraining loop adjacent to the first end of the leash and a handling loop adjacent to the second end of the leash, the restraining loop is disposed around the neck or shoulders of the animal, the fastener is fastened to the collar worn by the animal, and the user holds the handle with a first hand and the handling loop with a second hand.

16. The animal restraint system of claim 15 wherein the leash is inelastic.

17. The animal restraint system of claim 15 wherein the fastener is adapted to be removably fastened to the collar.

18. The animal restraint system of claim 15 wherein the handle comprises a fixed loop.

19. The animal restraint system of claim 15 wherein the braking mechanism is adapted to prevent the handle from passing through the first ring.

20. The animal restraint system of claim 15 wherein the first ring comprises an O-ring adapted to move along the leash between the first end and the second end.

21. The animal restraint system of claim 15 wherein the second ring comprises an O-ring fixedly disposed near the handle.
